(19) United States
(12) Patent Application Publication
(10) Pub. No.: US 2016/0148286 A1
(43) Pub. Date: May 26, 2016

(54) SYSTEM AND METHOD FOR ALLOCATING CONTRIBUTIONS TO RECIPIENTS AFFILIATED WITH A CAUSE

(71) Applicant: Green Beans Coffee Company, Inc., Larkspur, CA (US)

(72) Inventors: Jason Araghi, Mill Valley, CA (US); Clay Lingo, Novato, CA (US); Brian Laliberte, Parker, CO (US)

(73) Assignee: Green Beans Coffee Company, Inc., Larkspur, CA (US)

(21) Appl. No.: 14/885,039

(22) Filed: Oct. 16, 2015

Related U.S. Application Data
(63) Continuation of application No. 13/180,392, filed on Jul. 11, 2011, now abandoned.
(60) Provisional application No. 61/362,932, filed on Jul. 9, 2010.

(51) Int. Cl. G06Q 30/02

(52) U.S. Cl. CPC G06Q 30/0279

(57) ABSTRACT

A method for allocating standardized gifts to recipients. The method includes converting monetary gifts to a plurality of standardized gifts, distributing those gifts to a set of recipients, and providing a communication link between the donors of the standardized gifts and the recipients of the standardized gifts if the gift is accepted by the recipient. The distribution of the gifts may be determined based on a ranking of the gifts based on the initial gift size and date. The recipient pool may be determined based on a ranking of length of time since last gift received and the number of gifts received over a given period by the recipient. The communication link may be formed based on identification information of the donor associated with a gift and the identification information for the matched recipient. Unaccepted gifts may be recirculated and matched with other recipients.

### BACKGROUND OF THE DISCLOSURE

1. Field of Invention

This invention relates to a system and method for randomly allocating contributions by gifter to unknown recipients who are affiliated with one or more causes and exchanges of messages between the gifters and recipients.

2. Background

Making monetary or non-monetary contributions or gifts to individuals or organizations on line over the Internet is known. For example, one known method of sending gifts uses an online system that allows a gifter to select a gift or gift card and then specify the recipient. It is known to sponsor children in poor countries by making periodic contributions via the Internet towards the living expenses of the children who exchange letters and share pictures with the sponsors who register on line to make contributions. Under known contribution methods, the sponsor, donors or contributors may or may not know the identity of the recipients. On-line interface between the gift recipient and gifter is also known.

One known method of gifting for a cause involves purchasing gift items, e.g. cups of coffee, for troops who serve abroad. According to this method, which is known as “the Cup of Joe for a Joe Program,” gifters purchase “Cups of Joe” (COJs) for troops and send personal messages of gratitude for serving abroad. Green Beans Coffee, the assignee of the instant application, currently owns and operates more than 75 cafés throughout the world via a relationship with the military to support the troops. Under the COJ program, a customer contributes a dollar amount that provides free cups of coffee that are awarded to troops on a random basis and can provide a message of thanks that is passed-on to the award winner. In tum, troops sign-up to receive these awards and have the ability to respond to their gifter by returning a thank you as well. The cafes are notified of the winners where they come to receive their free cup of coffee. Under the COJ program, troop names are entered as gift recipients at cafes located in military bases. The name entry is based on forms submitted by the troops who wish to receive the purchased COJs by the gifters. The names of gifters along with gifter messages thanking the troops for their service is also collected. A gift allocation process is used for allocating the gifts to the troops along with an e-mail response mechanism for return-thank message form the troops, as further described below in more detail.

The gifter can contribute any dollar amount which are used towards purchasing Cups of Joe (COJs) at a specified cost, e.g., $2 per COJ. When the purchase is made, the total dollar amount is divided by $2 to determine the number of Cups of Joe (COJs) to be allocated to troops. For example, if a gifter contributes $20, ten (10) COJs are created. The gifter receives a confirmation of their purchase via e-mail. When the gifter purchases the COJ, they have the option of including a thank you message to the troops. The same message goes to each of the troops that are allocated to the contribution of the gifter, e.g. 10 troops would get allocated one COJ each.

Once contribution are made by the gifters, a number of created COJs are assigned to a specific troop. This is done by a batch process, capturing all new gifts and assigning them to the troops. The allocation is determined by several factors, including the total number of COJs awarded in the past to a troop and the time lapsed since the last COJ was awarded. Based on the foregoing criteria, each troop gets a “score.” Based on the score, new troops are awarded COJs at a higher priority, followed by troops with the least amount of COJ awards and the most amount of time lapsed since their last award. Once allocated, the troops receives e-mails with redemption notices about awarded COJs, and a link to a page where they can register their award. On that page, the troops can write messages back to the gifters. They also have the option of selecting whether or not they want their e-mail address included in the thank you back, so that the troops and the gifter can continue to correspond with each other.

Frequently, people refrain from contributing because of the impersonal nature of the system and the lack of feedback as to how their contributions helped. Similarly, recipients frequently value the contributions less because there is no human associated with it. Therefore, there exists a need for the ability to create a community via the continued communication vehicle with gift recipients associated with a good cause. An infrastructure is needed to support personalized communication shared between gifter and gift recipients without pre-existing relationships and enhance the experience of participation in the good cause.

### BRIEF SUMMARY OF THE DISCLOSURE

Briefly, according to the present invention, an information system comprises a plurality of gifter user devices associated with a plurality of gifters. The gifters are associated with one or more specified causes. A plurality of recipient user devices are associated with a plurality of recipients who meet eligibility criterion for being affiliated with the one or more specified causes. One or more application servers are coupled to the pluralities of gifter and recipient user devices over a network. A database is accessible by the one or application servers for storing gifter contribution information associated with the plurality of gifters and for storing recipient information associated with the plurality of recipients over the network. One or more processors process the contribution information to associate a redeemable gift number to each one of the plurality of gifters and process the recipient information to associate a reward priority number to each one of the plurality of recipients. A recipient with a higher reward priority number has a higher probability than a recipient with a lower reward priority number of receiving a reward notice linking such recipient with a gift redemption information. A process randomly matches a gifter with the recipient that is linked with the gift redemption information.

### BRIEF DESCRIPTION OF THE DRAWINGS

The accompanying drawings, which are incorporated in and constitute a part of this specification, illustrate an implementation of the invention and, together with the description, explain the goals, advantages and principles of the invention. Corresponding reference numerals indicate corresponding parts throughout the several views of the drawings. In the drawings:

FIG. 1 is a block diagram of a system that implements contributions allocation method of the present invention;

FIG. 2 is a flow chart of an exemplary contributions allocation method implemented in the system of FIG. 1;

FIG. 3 shows program process flow for a contributions allocation process implemented according to one example of the present invention, namely, the Cup of Joe (COJ) program;

FIG. 4 shows a web portal diagram that via a specified Uniform Resource Locator (URL) allows a gifter secure log-in, secure credit card capture and processing as well as the ability to enter personalized messages of thanks to troops;

FIG. 5 shows a web portal diagram for a troop sign-up page;

FIG. 6 shows a form corresponding to winning a COJ award used for registering the awarded COJ and redeeming it at a base or any other designated location; and

FIG. 7 shows exemplary charts based on data gathered on COJ implementation of the invention.

### DETAILED DESCRIPTION OF THE DISCLOSURE

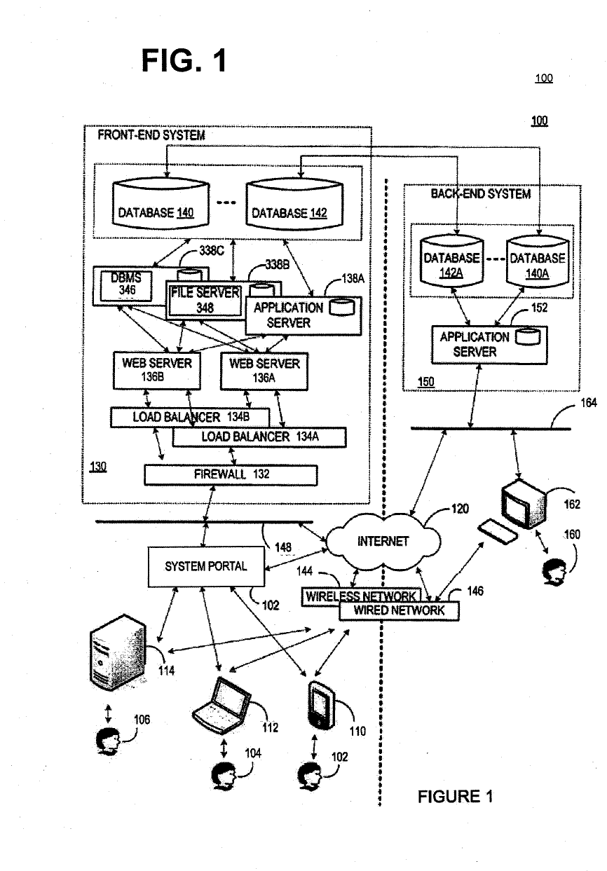

FIG. 1 shows an exemplary block diagram of a system 100 that delivers gifts from gifters to recipients according to an exemplary embodiment of the present invention. As herein used, gifter, contributor or sponsor is a user of the system 100 who registers to make a contribution or purchase gift that is associated with one or more specified causes, which are affiliated with one or more recipients. As described later in more detail, the system 100 allows for recording information regarding the gifters and recipients who are the participants in a gift program or otherwise users of the system 100, including receiving, storing, managing, manipulating, retrieving, reporting, transmitting and deleting information regarding participants. Participants include gifters and recipients or anybody administering the contribution or gift program for specified causes. The system 100 allows for establishing a retrievable identity associated with participants via an online accounts accessible by a plurality of users having authenticated access, as described further below.

A contribution or gift from a gifter may include any type of contributions, including money, pledged assets or any type of item that is purchased by gifters for recipients who are unknown to the gifters. The gifters may be any type of entity interested in one or more specified causes. The gifts or contributions under the present invention are awarded to the recipients randomly. A gifter may be an individual, a business, a club, a school, a family, a non-profit organization, or any other entity capable of making a contribution and interested in making contributions to recipients affiliated with a cause. Similarly, a recipient may be an individual, a business, a club, a school, a family, a non-profit organization, or any other entity capable of receiving contributions or gifts. As further described below, the gifters and recipients register with the system 100 for one or more specified causes. A cause with which a recipient may be affiliated with could be predefined according to specific eligibility criteria such as a victim of a specific natural disaster, a victim of a debilitating disease, or a member of the armed forces serving in a war zone or any other criteria.

The system and method for allocating contributions from gifters receive contribution information over a network from a plurality of gifters associated specified causes. The received contribution information from the gifters over a time period are processed for association with a pool of one or more redeemable gifts, with each gifter being associated with a gift reward balance based the gifter's contribution. Also received over the network are information about recipients who meet criterion for affiliation with the specified causes. Based past reward history, the recipients are ranked for reward priority. Recipients with higher reward priority are assigned at least one redeemable gift. Upon assignment, reward notices are transmitted to the awarded recipients, linking them with information about redeeming the rewarded gift. A process randomly matches a gifter associated with at least one gift with the recipient upon redemption of the gift by the recipient.

In one exemplary implementation described herein, contributions may be in the form of cups of coffee called “Cups of Joe” (COJs) purchased by gifters along with letters of thank to troops, airmen, sailors, marines or coast guardsmen overseas. Because the person who sends the COJ and the service member who receives it are matched on a completely random basis after the recipient's reward priority determination, the gifter does not have to personally know anyone who is serving overseas in order to send the COJ. Troops deployed overseas sign up to participate in the program by enrolling on a website. When contributions are received, a process is used to randomly assign the COJ gifts to the troops.

The system sends e-mail notices informing a troop that a Cup of Joe has been awarded by a gifter and that a gifter message or letter is received. The troop is given an opportunity to redeem the award and write back to the gifter by registering the COJ for pick up at a designated cafe on his or her base.

The gifters and recipients according to the present invention use or are otherwise associated with corresponding user devices. A user device associated with a gifter or a recipient may be any type of electronic device, such as a handheld device (e.g., iPhone®, Blackberry®, Kindle®), personal digital assistant (PDA), handheld computer, a laptop computer, a desktop computer, a tablet computer, a notebook computer, a personal computer, a smart phone, etc. Accordingly, a plurality of gifter user devices are associated with a plurality of gifters. The gifters are associated with one or more specified causes. A plurality of recipient user devices are associated with a plurality of recipients who meet eligibility criterion for being affiliated with the one or more specified causes.

According to this embodiment, the system 100 of FIG. 1 includes a front-end system 130 and a back-end system 150. The front-end system 130 also provides users 102, 104, 106, i.e., gifters or recipients, an online environment, e.g., a portal environment or social networking environment, wherein users 102, 104, 106 may register with the system, make contributions, receive and transmit messages, create messages, modify existing messages, and share the messages with other users 102, 104, 106. The back-end system 150 is used for system administration, development and implementation, information record keeping, as well as application developments for billing, marketing, public relations, etc.

The front-end system 130 interfaces with the user devices 110, 112, 114, allowing users 102, 104, 106 to interact with the online environment. The user devices 110, 112, and/or 104 are coupled to the system portal 140 via a network 142, which may be a LAN, WAN, etc. The system portal 140 acts as a gateway between the front-end system 120, the user devices 110, 112, and/or 114. Alternatively, the user devices 110, 112, and/or 114 may be coupled to the system portal 140 via the Internet 142 or through a wired network 146 and/or a wireless network 144.

In an exemplary embodiment, the user devices 110, 112, 114 execute a network access application, such as a browser or any other suitable application or applet, for accessing the front-end system 130. The users 102, 104, 106 may be required to go through a log-in session before receiving access to the online environment. Other arrangements that do not require a log-in session may also be provided in accordance with other exemplary embodiments of the invention.

In the exemplary embodiment shown in FIG. 1, the front-end system 130 includes a firewall 132 coupled to one or more web servers 136a-b, which provide various types of users or participant portals. The servers 136a-b are coupled to load balancers 134a-b, which perform load balancing functions for providing optimum online session performance by transferring client user requests to one or more of the application servers 138a-c according to a series of semantics and/or rules. To provide the online environment, the web servers 136a-b are coupled to one or more application servers 138a-c, each of which includes and/or accesses one or more front-end databases 140, 142, which may be central or distributed databases. The database can store various types of message content exchanged between the gifters and recipients, including audio, video or textual messages. The application servers serve as the interface of the online environment according to the present invention. The application servers also serve various modules used for interaction between the different users of the online system.

The application servers 138a-c may include a database management system (DBMS) 146 and/or a file server 148, which manage access to one or more databases 140, 142. In the exemplary embodiment depicted in FIG. 1, the application servers 138a and/or 138b provide online content to the users 102, 104, 106, including e-mails or other types of messages or content. Some of the content presented is generated via code stored either on the application servers 338a and/or 338b, while some other information and content, such as user profiles, user information, messages, or other information, which is presented dynamically to the user, is retrieved along with the necessary data from the databases 140, 142 via application server 138c. The application server 138b may also provide users 102, 104, 106 access to executable files which can be downloaded and installed on user devices 110, 112, 114 to render content to users 102, 104, 106. Installed applications may have branding and/or marketing features that are tailored for a particular application or user.

The central or distributed database 140, 142, stores, among other things, user information and user content including retrievable information relating to or associated with users, profiles, billing information, schedules, statistical data, user data, user attributes, historical data, demographic data, billing rules, statistical data, etc. Amongst the date stored in a user profile is data specifying the location of the user, User location information may be static, i.e., the location of a military base. The location information may also be dynamically generated based on the proximity of a user relative to a set of coordinates. Such dynamic location information may be provided by known location based applications that rely on terrestrial or satellite location determination techniques, such as the Global Positioning System (GPS) or cellular positioning systems. Any or all of the foregoing data can be processed and associated as necessary for achieving a desired objective associated with operating the system of the present invention.

According to the present invention one or more databases store profiles that specify the eligibility requirements for being gifters of each supported cause, requirements for being recipients affiliated with each supported cause and the criteria for each supported causes. Based on the specified profile requirements, the system presents the necessary user interfaces to the users who register as gifters and recipients for causes that are supported by the system of the present invention. According to the foregoing, one or more application servers are coupled to the pluralities of gifter and recipient user devices over a network. A database is accessible by the one or application servers for storing gifter contribution information associated with the plurality of gifters and for storing recipient information associated with the plurality of recipients over the network.

Updated program code and data are transferred from the back-end system 150 to the front-end system 130 to synchronize data between databases 140, 142 of the front-end system and databases 140a, 142a of the back-end system. Further, web servers 136a, 136b, which may be coupled to application servers 138a-c, may also be updated periodically via the same process. The back-end system 150 interfaces with a user device 162 such as a workstation, enabling interactive access for a system user 160, who may be, for example, a developer or a system administrator. The workstation 162 is coupled to the back-end system 160 via a local network 164. Alternatively, the workstation 162 may be coupled to the back-end system 150 via the Internet 142 through the wired network 146 and/or the wireless network 144.

The back-end system 150 includes an application server 152, which may also include a file server or a database management system (DBMS). The application server 152 allows a user 160 to develop or modify application code or update other data in databases 140a, 142a. A user 160 may also use the back-end system for the creation, modification, or removal of content. Basic database features, SQL-like language, data referential integrity and data access/reporting tools are used to operate the application, process and manage data repository. Standard/Commonly known development language and tools are used for down-stream enhancements and upgrades.

Setup and administration tools for the COJ implementation in the back end allows:
1. Enter, update café locations
   a. Enter basic location information, region and e-mail contact information
   b. Easy look-up/update mechanism
   c. Basis reporting with sort/filtering options
2. Review, update COJ troops tables
   a. Informational data
   b. Linked data from COJ gifter to COJ troops
3. Review, update COJ gifter orders
   a. View and report on linked data from COJ gifter to COJ troops
4. COJ ranking algorithm data elements
   a. Flexible data values can be updated that determine the ranking
   b. Ability to update the max number of assignments by priority

The backend also supports the following COJ real-time processes:
1. eCommerce Tool
   a. eCommerce e-mail Confirmation & Thank you from Corporate
   b. eCommerce Payment Process
2. Troop Sign-up
   a. Troop sign-up temporary e-mail
   b. Troop administration tools for basic information and status updates
3. Troop redemption of a COJ award
   a. Link COJ Troop to a COJ gifter

It would be appreciated that the system shown in FIG. 1 could be implemented in or make use of various cloud computing services. Software-as-a-Service (SaaS) is a model of software deployment whereby a provider licenses an application to customers for use as a service on demand. One example of SaaS is the Salesforce.com CRM application. Infrastructure-as-a-Service (IaaS) is the delivery of computer infrastructure (typically a platform virtualization environment) as a service. Rather than purchasing servers, software, data center space or network equipment, clients instead buy those resources as a fully outsourced service. One such example of this is the Amazon web services. Platform-as-a-Service (PaaS) is the delivery of a computing platform and solution stack as a service. PaaS facilitates the deployment of applications without the cost and complexity of buying and managing the underlying hardware and software layers. PaaS provides the facilities required to support the complete lifecycle of building and delivering web applications and services. An example of this would the GoogleApps. In various, but not all embodiments of the invention, computer languages may be used which include, but are not limited to, C, C++, Python, Objective-C, HTML, Java, and JavaScript. Other programming languages may be employed as well.

The hosted environment of the system 100 is available 7×24 as a web-hosted solution (ASP Model). Security and access involves secure sign-in with username and password, audit file of user activity and access levels based on application and data fields. The system 100 supports back-up & recovery via back-up procedures and system fail-safe, off-site storage via electronic media back-up and media rotation. The system 100 executes several automated processes that run daily jobs/processes. The system supports end of day (EOD) and real-time reporting for transactions, error reports, weekly activity reports, etc., which are available, as further described below.

The present invention could be implemented in information processing system, such as the one shown in FIG. 1, where gifters, recipients, or contributions, etc. are associated with corresponding information stored in one or more databases that are processed by appropriate nodes or processing units within the system 100. As such, the system 100 includes gifter and recipient interfaces created on corresponding user devices for interaction with the system according to the present invention. The users use the interfaces for data entry and registration with the system. For the COJ implementation, a custom COJ application is run on the system 100 that is able to scale the operation/application, provide real-time reporting and trouble-shooting tools, look-up COJ gifters, troops, responses, award winner recipients and the links between the COJ gifter and the award winner recipients. The system have also has functionality for building an environment that integrates with existing websites and is able to extended the COJ program and add other COJ-like products, such as tea or other types of beverages.

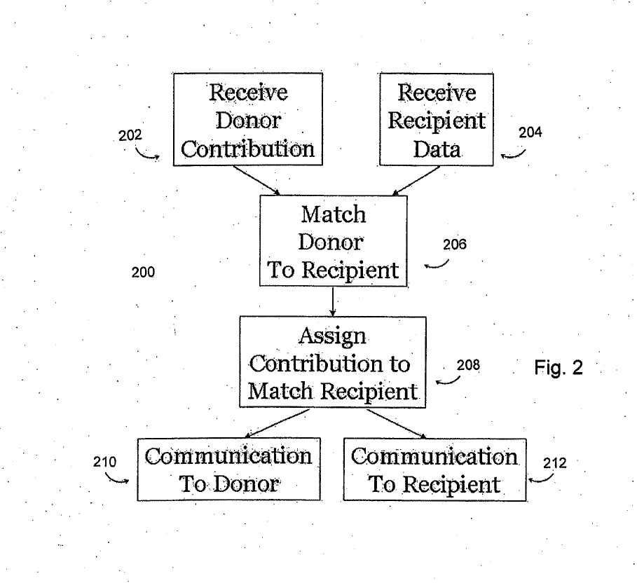

The general flow chart of contribution allocation method 200 implemented in the system 100 is shown in FIG. 2. The method 200 comprises the step 202 of receiving contributions from gifters who registers within the system 100 for a specified cause by creating an online account and entering requested information over a presented portal, including gifter name, address, phone number, birth date, profession and information about payment or contribution method. The collection of gifter contributions may including charging a credit card, accessing a bank account, dispatching a pick-up of goods from a residence or business, or any other means of collecting contributions. The contributions allocation method may include receiving multiple contributions from a single gifter or multiple gifters for specified causes. The method 200 may also include receiving a single contribution from a single gifter or multiple gifters for one specified cause or multiple causes selectable by one or more gifters who register for such causes. The step of receiving contributions may include receiving automatic periodic contributions as through a payroll deduction plan or from a bank account or credit card or through a pledge or purchase of an asset or item online. The gifters may specify a desired characteristic of the recipient or the preferred use of the contributions such as clothing, coffee, education, shelter or any other defined use. The information regarding such preferences is stored in the gifter profiles.

The method 200 also requires the step 204 of receiving data about a recipient. Similar to the gifters, the recipients affiliated with the specified cause register within the system 100 by entering the required information, including recipient name, address, phone number, birth date, profession, employer, employment rank, service record, vocational interests, family status, frequency of participation in the program, etc. One or more recipients may register for multiple causes provided that they meet the eligibility criteria for being affiliated by such causes. Based on the entered information and the stored requirements of a cause, the system determines whether the recipient could be affiliated with the registered cause. The system monitors and controls activity of the participants. The monitoring and controlling activity may include accepting or rejecting contributions, accepting or rejecting participants, verifying collected information, transmitting or deleting communications, suspending or holding participant activity, etc.

The method 200 further requires the step 206 of randomly matching the gifters with recipients. The random matching process involves the application of a deterministic or non-deterministic matching algorithm. In one embodiment, the recipients are matched with gifter according specified matching parameters. Matching may involve consideration of a gifter or recipient's status such as “active,” “not approved,” “on-hold,” “suspended,” “on-probation,” “inactive,” or any other status identifiers which are stored in corresponding user profiles of the gifter or recipient, as further described below. The algorithm for matching the gifter to a recipient may include manipulation of information about the contribution, the gifter or the recipient and may involve steps of accelerating, delaying, prioritizing, ranking, selecting, advancing or singling out a participant. Accordingly, the gifter and recipient profiles for each user includes accelerating, delaying, prioritizing, ranking, selecting, advancing or singling out that is used in the matching process. One type of data that may be associated with the recipient is any delay associated with receiving contributions or gifts that may be associated with the recipient's location, e.g., a remote military base, or recipient's access to the system.

In one embodiment, the method 200 requires the step 206 of assigning a contribution to a matched recipient. One feature of the present invention requires matching gifters with recipients takes place at the time the recipient chooses to accept a gift Assignment step includes calculations of contributions amounts or pledges relative to assigned gifter. Such assignment can also require calculation of contributions remainder relative to assigned pledges and application of contributions specified by the gifter or recipient. Reranking or prioritizing of the gifter or participant data for future matching may also be considered as a part of the allocation of contributions. The assignment/allocation process is described in more detail below.

The method 200 requires providing communication to the gifter 210, and providing communication to the recipient 212. The step of providing communication to the gifter 210 may include any type of communication and any means of provision. The communication may be provided electronically by a suitable electronic message delivery mechanism incorporated within system 100. The communication may include any information including gratitude from the recipient, gratitude from the body organizing the contributions opportunity, notification of delivery of the contribution, identification of the recipient, identification of the recipient's contact information, notification of the results of the contributions for the recipient or any other information, such as reminders for future contributions. The communication may include a finite list of predefined messages or a free-form message. The step of providing communication to the recipient 112 may also include providing a means for direct communication between the gifter and the recipient such as through e-mail or any other means of communication. The communication may include any information including best wishes from the gifter, best wishes from the body organizing the contributions opportunity, notification of selection of the recipient, identification of the gifter, the gifter's contact information, notification of the motivation for the contributions or any other information, such as reminders for future participation or contribution. The communication may include a finite list of predefined messages or a free-form message that are pre-stored.

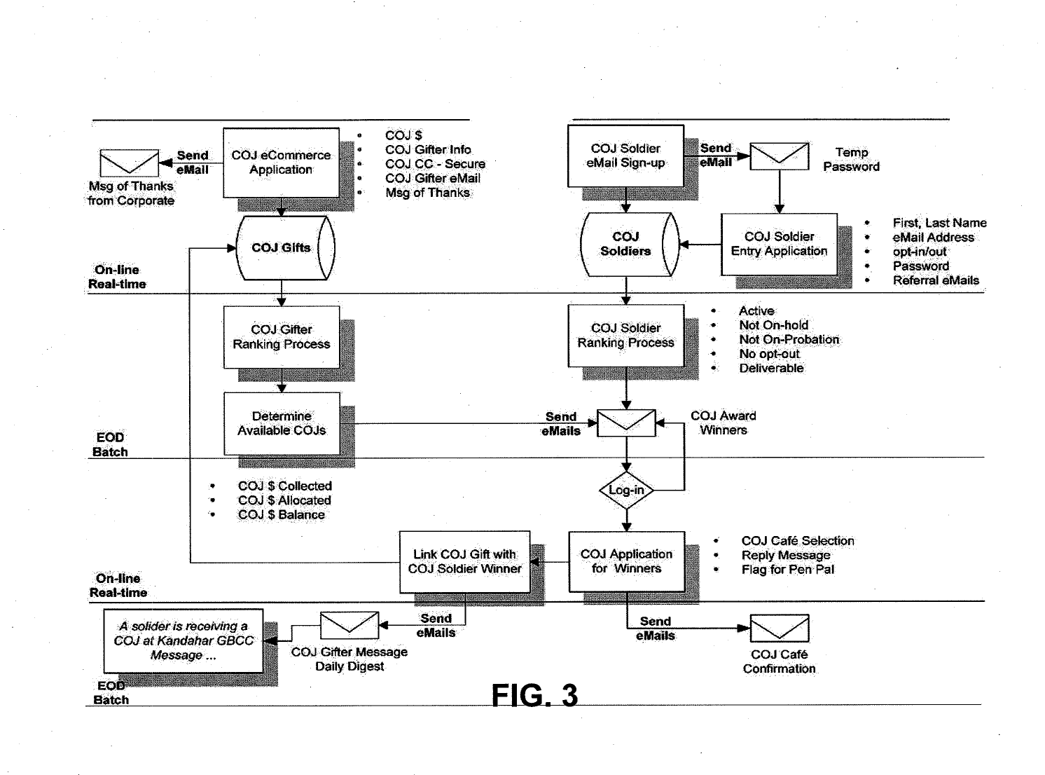

FIG. 3 shows a program process flow for a contributions allocation process implemented according to one example of the present invention, namely, the Cup of Joe (COJ). The implementation of the COJ allocation and redemption process of FIG. 3 is based on COJ purchases by gifters for redemption by troops who receive redemption notices based on random matching with gifters. A COJ eCommerce application allows for purchase of COJs by gifters having profiles containing COJ gifter information. COJ gifters can perform online financial transactions including entering of credit card information, mailing demographics, e-mail address, opt-in, referral drop-down, and referrer (Source/Coupon code); performing secure online processing; and accessing a basic shopping cart. A secure link allows gifters to draft gifter e-mails containing messages of thanks which are sent to troops as redemption notices. A COJ troop e-mail signup application allows troops sign up for the COJ program by sending an e-mail containing a temporary password that allows the soldier to use a COJ troop entry application to enroll in the program by entering requested information. A COJ Gifts database contain information about purchased gifts and gifter messages. A COJ troops database contains information about the recipients enrolled in the program. When a notice goes out, the soldier receives an e-mail with a notice that they've been awarded a Cup of Joe, and a link to a page where they can register their award. Once the soldier clicks on the link in the e-mail, and as they arrive at the COJ registration page, a match between the troop and the gifter occurs randomly. This matching occurs at the time a COJ participant opts to receive an awarded COJ. The resulting page shows the thank you message from the gifter that they were just matched with. According to the above, one or more processors process the contribution information to associate a redeemable gift number to each one of the plurality of gifters and process the recipient information to associate a reward priority number to each one of the plurality of recipients. According to the present invention, a recipient with a higher reward priority number has a higher probability than a recipient with a lower reward priority number of receiving a reward notice linking such recipient with gift redemption information. A process randomly matches a gifter with the recipient that is linked with the gift redemption information.

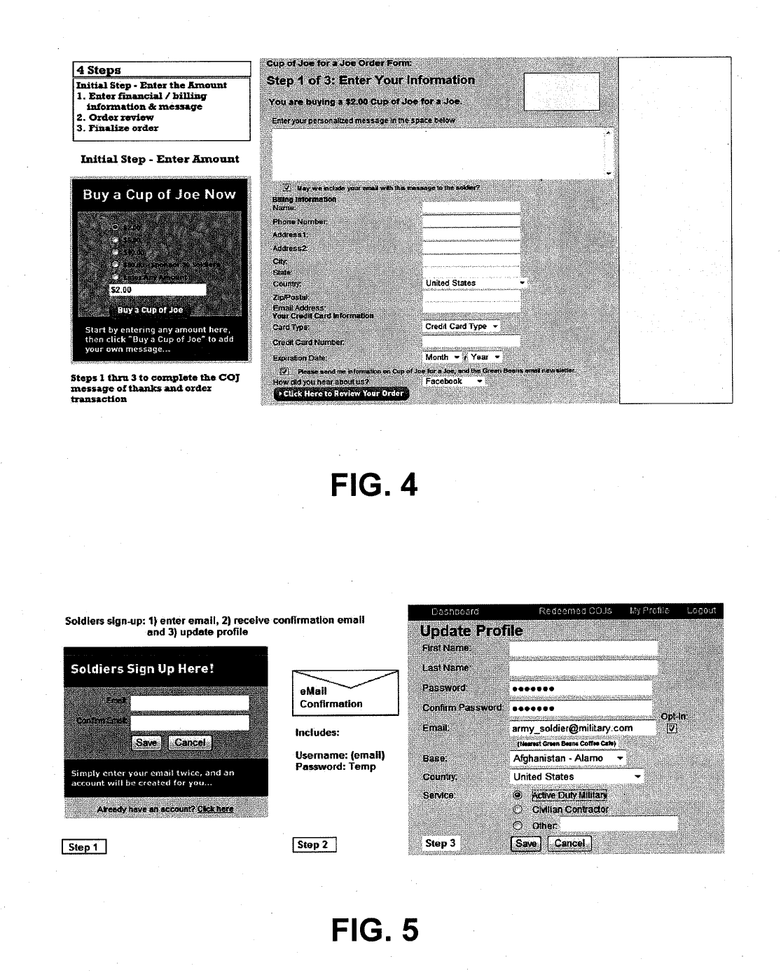

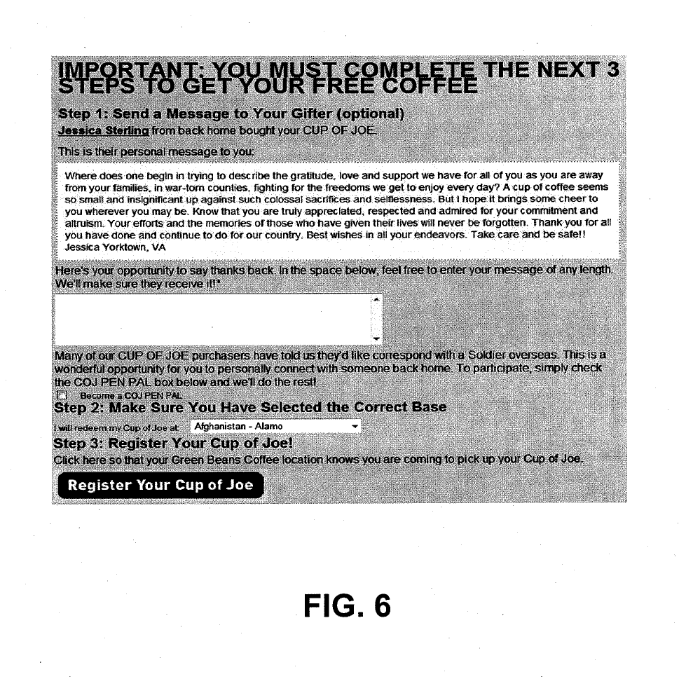

FIG. 4 shows a web portal diagram that via a specified Uniform Resource Locator (URL) allows a gifter secure log-in, secure credit card capture and processing as well as the ability to enter personalized messages of thanks to troops. FIG. 5 shows a web portal diagram for a troop Sign-up page. Troops sign-up using an e-mail address as their username. Once their e-mail address is received, a confirmation e-mail is sent to ensure valid e-mail address and to complete registration. Once troops sign up and COJ gifters purchase COJ gifts, an allocation process is executed to allocate the COJs to troops. FIG. 6 shows a COJ award winning form that is used for registering awarded COJ and redeeming it at a base or any other designated location.

Under one embodiment of the allocation algorithm, COJs gifter can get allocated at any time of periodically once they are ranked/prioritized. The ranking/priority is set once a day according to an End-of-Day (EOD) ranking process. Under the EOD ranking process priority is given to aged COJ gifters that are not completely allocated. In one embodiment, lower contribution awards are prioritized so that fulfillment occurs sooner for lower-dollar value gifts, which can be adjusted on the back end by an admin.

The COJ gifters are ranked by priority by Allocation % by days Aged. In one embodiment, no more than Assign Max number of COJ troops is assigned to a COJ gifter per cycle, followed by the next COJ gifter. The rank is maintained until the ranking process is run at the End-of-Day (EOD). The ranking process allows for manually prioritizing such that allocation could be done one-by-one.

Under the COJ implementation, the EOD process include:
1. COJ soldier reminder e-mails
   a. COJ Winner Reminder (Daily or Every third Day)
   b. COJ On-Probation e-mail (Daily or Weekly)
   c. COJ finalize Registration e-mail (Upon registration)
2. Ranking process (Daily)
   a. Rank COJ gifters
   b. Rank COJ soldiers
3. Determine number of COJ winners (Daily)
   a. COJ winner (Initial e-mail)
   b. COJ Thanks You e-mail Digest (Daily)
   c. Café notification of COJ Award Winners (Daily)
4. Identify all undeliverable e-mail address
   a. Set Undeliverable Flag to current date
5. Identify all Non-responders
   a. Set On-Probation Flag to current date
6. Promotional Engine to Support large COJ gifter Transactions

Troops are notified by troop priority/ranking according to the following algorithm:
1. Keeping track of the number of times a COJ troop is awarded and each date awarded.
2. Keeping track of the creation date a troop signs-up to the COJ Program.
3. Troops become active when they log-in their account and fill-in basic information. Otherwise they are “Not Approved”. Accounts can be flagged as “Not Approved” due to abuse of the program or ineligibility of the recipient for not meeting a specified cause's criteria.
4. Troops have the ability to flag their account as “On-Hold”. Set On-Hold to current date.
5. Troops that are in-active (do not respond to e-mail notifications) become “On-Probation”. Inactivity is failure to respond to an e-mail award. Set On-Probation to current date.
6. Troops with undeliverable e-mail addresses get flagged as “Undeliverable”. Set Undeliverable to current date.
7. Troops can opt-out as well, set to current date.
8. Set COJ troop RANK Status to NO: Not Approved, On-Hold, On-Probation, Undeliverable and Opt-Out. Otherwise, Rank Status will be set to YES
9. If Rank Status is YES, rank by number of awards by (date created for new or last award date).

Troops are notified of their award by e-mail. Since some troops will not respond timely or not at all, we have to send e-mail notifications often and more than the total available COJ gifter Pool:
1. Determine the Available COJ pool from all ranked COJ gifters remaining balance, COJ pool balance, amount of the COJ gift—allocated amount.
2. Calculate the Availability COJ Pool by the COJ pool balance—total number of Award e-mails Sent.
3. Using the Available COJ Pool and that is the number of award e-mail notifications that can be sent.
4. Using the troop ranking, send out e-mail awards equal to the available COJ pool.
5. Date stamp the date of the award availability and send e-mail.

Due to troop turnover, lack of internet connectivity at times and being away on mission or sent back home, COJs can be reallocated to troops ready to accept awards. In one embodiment, if a troop fails to respond to an e-mail Award Notification within certain number of days (sic) days, they are put On-Probation e-mail Activation/Re-Activation Frequency. Due to responses to e-mail notifications, troops receive several notification reminders:
1. E-mail Award Winner—COJ troops Not On-Hold, Not On-Probation and Selected as an award winner, will receive an initial e-mail and follow-up e-mail every 3 days.
2. Probation e-mail—troops On-Probation will receive an On-Probation e-mail once a week.
3. Sign-up e-mail confirmation with temporary password—troops with a temporary password will be e-mailed once a week to complete their sign-up process.

For reward redemption, troops respond to their COJ winner e-mail and log-in:
1. Once they log-in, they are linked with a COJ gifter.
2. The gifter's message of thanks is displayed.
3. The COJ troop can type in their message of thanks and opt-in as a pen pal.
4. They also select the café they will redeem and “Register Cup of Joe”.
5. Finalizing this form generates:
   a. Daily e-mail to the café manager and
   b. Daily e-mail digest to the COJ gifter.

If the troop exits from this page without completing:
1. The link with the COJ gifter and COJ troop award winner is broken.
2. The COJ award winner who did not complete the COJ and is still eligible for a COJ award.
3. The COJ gifter is placed back into the ranking as if this transaction did not occur.

Based on the above, the redemption notices are processed daily by a batch run of award notice e-mails sent to the recipients. According to one embodiment of the present invention, the rate of transmitted award notices can be adjusted, upward or downward, based on gift redemption rate. Depending on redemption trends, the award messaging can be “overclocked” (or “underclocked”) by sending a number of award notices above (or under) the number of COJs that have been purchased by the gifters. For example, in one embodiment, if redemption rates are 50%, the number of notices that go out can equal up to 200% of recent purchases. Adjustments to the overclocking (or underclocking) process and matching of redemption notices to purchases by gifters occurs daily and automatically based on decision parameters that rely on data gathered from COJ activities.

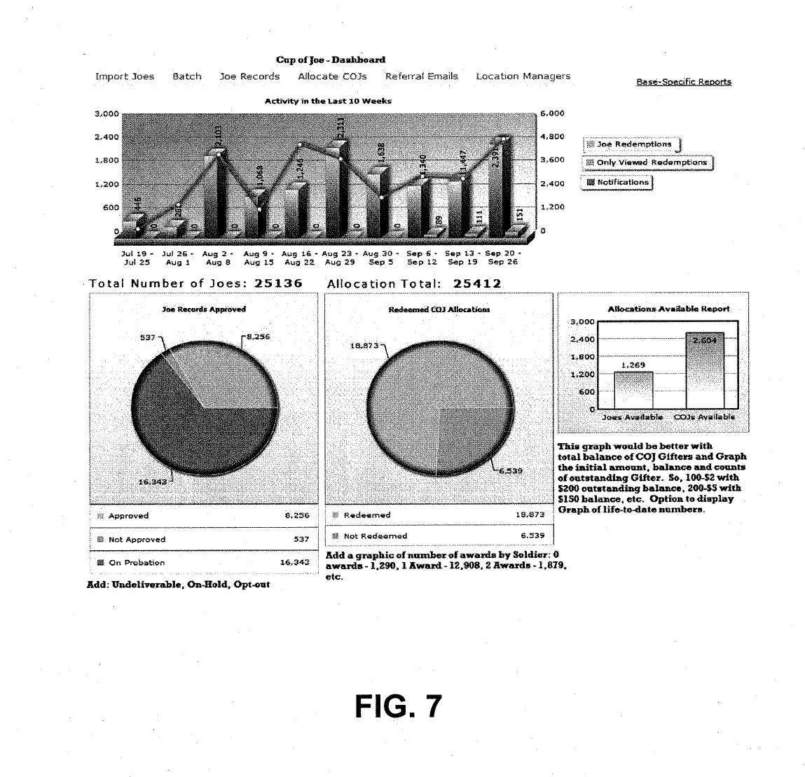

FIG. 7 provides exemplary activity charts. Example provided show summary and drill-down reporting, including:
a. View and report on COJ troop Sign-ups by café
b. Display data in the following columns: Last-Week, This-Week, MTD, YTD, LTD
   i. Sign-ups
   ii. Undeliverable
c. Display data in the following Columns: MTD, YTD, LTD
   i. Allocated
   ii. On-hold
   iii. On-Probation
   iv. COJ Redeemed
   v. summary & Drill-down Sales Source Code/Coupon Codes Reporting

In one embodiment, the award notice and matching processes are based on switches that can be set to address the various decision parameters within the allocation algorithm. In one embodiment, switches are used that affect how much overclocking happens. One switch adds nominal overclock amounts, and anther switch goes by percentage of previous day purchases. For example, if a 50% switch is selected, the algorithm overclocks by 50% of the previous day's purchases every day until it is reset. Thus, there are two percent-based switches and one nominal overclock. One switch looks at all allocations outstanding and allocates based on that number. Another switch looks at the previous day purchases and allocates based on that number. Finally, an operator can manually overclock by a nominal amount if necessary. The two percent-based switches roll forward day-to-day until they are reset. The nominal amount is done once and does not roll to forward days.

According to one feature of the present invention, assignment of the COJ purchases to troops does not occur immediately, allowing the system to gauge responses and to react by adjusting the award messages rate to maintain a desirable rate of response per gifter. According one embodiment of the invention, COJ purchases are not assigned to troops immediately. Rather, such purchases are matched according to an award acceptance by a troop. As part of this matching process, acceptance rate of awards can be measured and overclock new allocations accordingly to drive a desired rate of response per gifter.

According to another feature, the location of the recipients is taken into account for setting the time gifts are redeemed. For example, troops in Afghanistan may require more time in responding to the award notices. In order to reduce the amount of time gifters have to wait for receiving recipient responses without having the gifter waiting for their response. An example might be a troop receiving a notice that they can redeem a gifted COJ a month ago, redeems today, and is assigned and linked to a COJ gifter that in fact purchased its gift yesterday. Thus, the system and method of the invention accommodate gifting to troops who take longer to respond. Also the matching algorithm matches troops who, based on their location, might experience delays in responding to received gift award notices with gifters who may have contributed gifts in a more recent past relative to the delays. The advantage of this feature is that a troop could be kept in an active recipient pool longer, and allow for driving better near term response to recent gifters.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method of allocating standardized gifts, the method comprising:
receiving a plurality of monetary gifts from a plurality of donors;
receiving identification information from each of the plurality of donors;
receiving identification information for each of a plurality of recipients;
converting the plurality of monetary gifts into a plurality of standardized gifts, wherein each of the standardized gifts is associated with its donor of the plurality of donors;
assigning a rank to each of the plurality of standardized gifts using a gift ranking model;
assigning a rank to each of the plurality of recipients using a recipient ranking model;
matching a subset of the plurality of standardized gifts based on the gift rank with a subset of the plurality of recipients based on the recipient rank, wherein each of the subsets has an identical number of members;
notifying each member of the recipient subset of the matched gift;
receiving an acceptance notification for each matched gift accepted by each of the matched recipients;
generating a communication link between each of the matched recipients and each donor associated with the matched gift, wherein the communication link is based on the identification information for each matched recipient and the identification information for each of the plurality of donors associated with the matched gift; and
returning non-accepted matched gifts to the plurality of standardized gifts.

2. The method of claim 1, wherein the recipient ranking model comprises an algorithm based on a length of time since each of the plurality of recipients has last received a standardized gift and a number of standardized gifts that have been received by each of the plurality of recipients.

3. The method of claim 1, wherein the gift ranking model comprises an algorithm based on a length of time since each of the plurality of monetary gifts associated with the standardized gifts has been received and a value of each of the monetary gifts.

4. The method of claim 1, wherein the standardized gifts are of equal monetary value.

5. A non-transitory computer-readable medium product, the medium comprising instructions thereon that, when executed, cause a processor to perform a method, the method comprising:
receiving a plurality of monetary gifts from a plurality of donors;
receiving identification information from each of the plurality of donors;
receiving identification information for each of a plurality of recipients;
converting the plurality of monetary gifts into a plurality of standardized gifts, wherein each of the standardized gifts is associated with its donor of the plurality of donors;
assigning a rank to each of the plurality of standardized gifts using a gift ranking model;
assigning a rank to each of the plurality of recipients using a recipient ranking model;
matching a subset of the plurality of standardized gifts based on the gift rank with a subset of the plurality of recipients based on the recipient rank, wherein each of the subsets has an identical number of members;
notifying each member of the recipient subset of the matched gift;
receiving an acceptance notification for each matched gift accepted by each of the matched recipients;
generating a communication link between each of the matched recipients and each donor associated with the matched gift, wherein the communication link is based on the identification information for each matched recipient and the identification information for each of the plurality of donors associated with the matched gift; and
returning non-accepted matched gifts to the plurality of standardized gifts.

6. The non-transitory computer-readable medium product of claim 5, the medium comprising at least one of: i) a computer server, ii) a workstation, and iii) a hard disk.
